(19) United States
(12) Patent Application Publication
(10) Pub. No.: US 2003/0030369 A1
(43) Pub. Date: Feb. 13, 2003

(54) Method for forming a passivation layer for organic light-emitting devices

(75) Inventors: An Shih, Pu Yan Siang (TW); Chorng-Shyr Jou, Yangmei Cheng (TW)

Correspondence Address: BACON & THOMAS, PLLC, 625 SLATERS LANE, FOURTH FLOOR, ALEXANDRIA, VA, 22314

(73) Assignee: Ritdisplay Co.,, Hsinchu Hsien (TW)

(21) Appl. No.: 10/212,162

(22) Filed: Aug. 6, 2002

(30) Foreign Application Priority Data
Aug. 10, 2001 (TW) 90119708

(51) Int. Cl. H01J 33/00; H01J 1/62

(52) U.S. Cl. 313/504

(57) ABSTRACT

A method for fabricating an organic light-emitting device comprises in turn the steps of: providing a substrate; forming a first electrode corresponding to a light emission area; forming a stripe-shaped photoresist layer on the substrate having the first electrode wherein the photoresist layer is above the substrate having the first electrode; depositing an organic light-emitting medium layer on the first electrode in the exposed areas between the stripe-shaped photoresist layers to form a plurality of first electrode areas including the organic light-emitting medium layer on the first electrode; forming a second electrode on the organic light-emitting medium; forming a stress-relief layer on the second electrode wherein the stress-relief layer is a thin film of silicon oxynitride or polymer; and forming a passivation layer on the stress-relief layer wherein the passivation layer is an amorphous silicon, an inorganic nitride or an inorganic oxide.

### BACKGROUND OF THE INVENTION

1. Field of the Invention

The present invention relates to a method for forming a passivation layer, and particularly, to a method for forming a passivation layer for organic light-emitting devices.

2. Description of Related Art

Organic light-emitting display (OLED) devices excited by an electrical current for light emission have attracted the attention of the people in display industry and have become a new generation of flat panel display recently in view of its advantages of lightweight, high contrast, fast response time, low power consumption and high brightness. However,there are a number of technical obstacles remain unsolved since the OLED technology is newly developed.

One of the practical issues of the mass production for the OLEDs is how to increase the lifetime of an OLED device. At present, either small molecule-based or polymer-based organic light-emitting device is susceptible to reacting with moisture and oxygen. Such reactions cause damage to the organic light-emitting device and shorten its lifetime. So far, the damage is prevented by providing a glass cover with sealed frame boundary by UV-glue so as to keep moisture from entering the organic light-emitting device. However, the use of such a UV-glue sealing technique is not so effective that moisture penetrates in the organic light-emitting device and causes the organic light-emitting device to be damaged. Recently, it has been proposed to provide a desiccant to increase the lifetime of the organic light-emitting device. But the high cost of the desiccant refrains from adoption for mass production of the OLEDs. Further, some manufacturers use a spin coating technique to form polymeric passivation for waterproof function. However, the spin coating technique for such polymer is not so effective in practice. Moreover, the spin coating technique cannot be incorporated with a shadow mask for covering the pixel electrode pad of the panels, and therefore, is not suitable for mass production.

Recently, a film of a single material such as silicon nitride (SiN) or aluminum oxide formed by plasma-enhanced chemical vapor deposition (PECVD) or sputtering has been proposed to provide a passivation layer for waterproofing. However, since a very thick mushroom-shaped rampart having a thickness of about 2 to 5 μm is formed on the OLED panel (as shown in FIG. 1). The passivation is required to have a thickness up to 1 μm or more to be effective for waterproofing and to fully encapsulate the mushroom-shaped rampart. The formation of a nitride (such as SiN, AlN, or AlCrN) or an oxide (such as SiO or AlO) having a thickness up to 1 μm or more directly on the organic film frequently results in large stress in the film and wrinkle which deteriorates the waterproof function as moisture-contact happens. In addition, it even takes longer time to form a nitride or an oxide having a thickness up to 1 μm or more, and thus, not suitable for mass production.

Therefore, it is desirable to provide a method for forming a passivation layer for organic light-emitting devices to mitigate and/or obviate the aforementioned problems.

### SUMMARY OF THE INVENTION

It is therefore an object of the present invention to provide a method for processing the surface of an OLED panel which prevents the OLED from being damaged by moisture and/or oxygen and increases the lifetime of the OLED panel.

Another object of the present invention is to provide a method for processing the surface of an OLED panel which reduces the stress of the passivation layer on the surface of the OLED panel and the possibility of forming any wrinkle which may cause damage to the OLED panel surface.

It is still another object of the present invention is to provide a method for processing the surface of an OLED panel which shortens the processing time for forming a passivation layer on the surface of the OLED panel and increases the speed of fabricating and planarizing the passivation layer on the surface of the OLED panel.

To attain the above-mentioned objects, a method for fabricating an organic light-emitting device according to the present invention, comprises following steps: providing a substrate; forming at least one first electrode corresponding to a light emission area on said substrate; forming a stripe-shaped photoresist layer on said substrate having said first electrode, wherein said photoresist layer is protruding from the surface of said substrate having said first electrode; depositing an organic light-emitting medium on said first electrode in said exposed areas between said stripe-shaped photoresist layers; forming at least one second electrode on said organic light-emitting medium; forming a stress-relief layer on said second electrode wherein said stress-relief layer is a thin film of silicon oxynitride or polymer; and forming a passivation layer on said stress-relief layer wherein said passivation layer is an amorphous silicon, an inorganic nitride or an inorganic oxide.

A method for fabricating an organic light-emitting device according to the present invention comprises the steps of: providing a substrate; forming at least first electrode on said substrate; forming an organic light-emitting medium layer on said first electrode; forming at least one second electrode on said organic light-emitting medium layer; and forming a passivation layer on said second electrode wherein said passivation layer is an amorphous silicon.

An organic light-emitting device fabricated according to the present invention comprises a substrate; a plurality of first electrodes formed in parallel with each other on said substrate; a plurality of stripe-shaped photoresists on said substrate having said first electrodes; a plurality of organic light-emitting medium layers deposited on said first electrodes; a plurality of second electrodes formed on said organic light-emitting medium layers; a stress-relief layer which is a thin film of silicon oxynitride or polymer formed on said second electrodes; and a passivation layer which is an amorphous silicon, an inorganic nitride or an inorganic oxide formed on said stress-relief layer.

An organic light-emitting device according to the present invention comprises: a substrate; at least one first electrode formed on said substrate; an organic light-emitting medium layer deposited on said first electrode; at least one second electrode formed on said organic light-emitting medium layer; and a passivation layer which is an amorphous silicon formed on said second electrode.

The present invention uses a PECVD or vapor deposition polymerization (VDP) method to quickly form a low-stress polymer or silicon oxynitride (SiOₓN_{y}) layer having a thickness up to 1 μm or more to serve as a stress-relief layer, and then form a thin and dense inorganic protective layer for waterproofing. The protective layer can be formed quickly and will not result in any wrinkle as protective layer is contacted with moisture. Accordingly, the present invention is adaptable for mass production. In addition, because an amorphous silicon layer formed by PEVCD at a low temperature is more dense than a SiN layer, the present invention herein proposes a dual-layer construction of amorphous silicon and SiN to act as a protective layer wherein the thin SiN film serves as an isolation layer and the thin amorphous silicon film protects the thin SiN film from being oxidized.

To illustrate the present invention, exemplary embodiments of a method for forming a passivation layer for organic light-emitting devices will now be described with reference to the accompanying drawings.

### BRIEF DESCRIPTION OF THE DRAWINGS

FIG. 1 is a cross-sectional view of a surface of the conventional OLED panel;

FIG. 2 is a cross-sectional view of a surface of a first example of an OLED panel according to the present invention;

FIG. 3 is a cross-sectional view of a surface of a second example of an OLED panel according to the present invention; and

FIG. 4 is a cross-sectional view of a surface of a third example of an OLED panel according to the present invention.

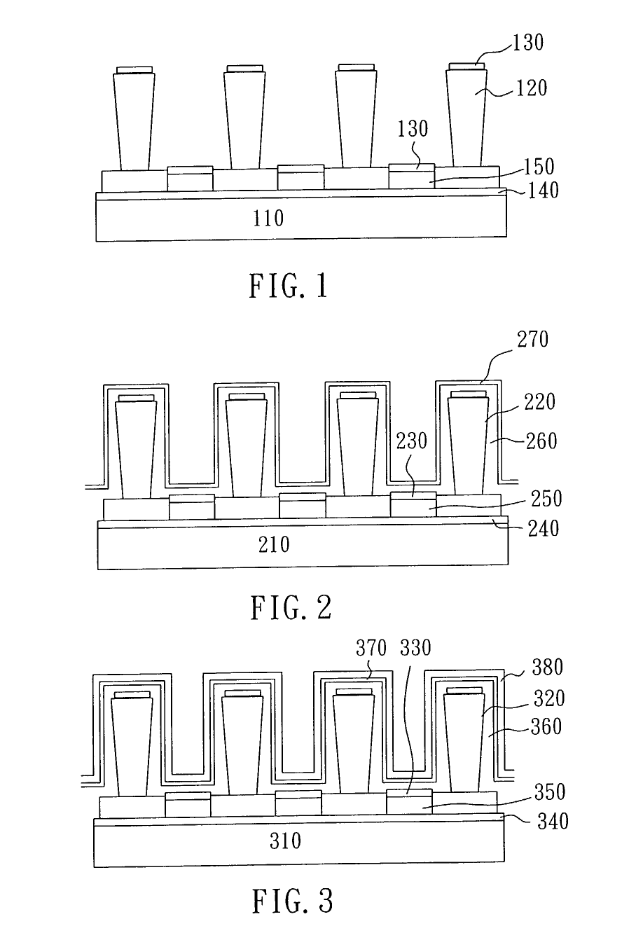

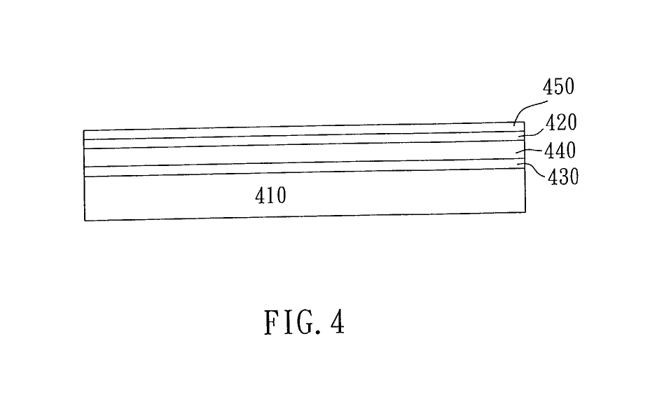

### DETAILED DESCRIPTION OF THE PREFERRED EMBODIMENT

To further prevent moisture from infiltrating the organic light-emitting device, an additional protective layer can be provided if necessary on the passivation layer of the organic light-emitting device of the present invention, in addition to the formation of the stress-relief layer and the passivation layer. The material of the additional protective layer of the organic light-emitting device according to the present invention is not limited, preferably, the protective layer is a polymer film; more preferably, the protective layer is PTFE(polytetrafluoroethylene). The passivation layer of the organic light-emitting device according to the present invention is an amorphous silicon, an inorganic nitride or an inorganic oxide. The amorphous silicon passivation layer of the organic light-emitting device according to the present invention is not limited, preferably, the amorphous silicon passivation layer is grown at a low temperature. The nitride passivation layer of the organic light-emitting device according to the present invention is not limited. Preferably, the nitride is SiN, Al N or AlCrN. The oxide passivation layer of the organic light-emitting device according to the present invention is not limited. Preferably, the oxide is SiO₂ or Al₂O₃. The method for fabricating the polymer film in stress-relief layer of the organic light-emitting device according to the present invention is not limited. Preferably, parylene is deposited on the second electrode before its formation on the second electrode by VDP or PEVCD. The method for fabricating the SiON stress-relief layer of the organic light-emitting device according to the present invention is not limited. Preferably, the SiON film is formed on the second electrode by PECVD. The method for fabricating the protective polymer film of the organic light-emitting device according to the present invention is not limited. Preferably, parylene is deposited on the passivation layer before its formation on the passivation layer by VDP or PEVCD. The organic light-emitting device of the present invention can further comprise a patterned polyimide layer on the OLED substrate and the first electrode if necessary. The first electrode and the second electrode of the organic light-emitting device according to the present invention are alternatively disposed, and preferably, perpendicular to each other.

The OLED panel fabricated according to the present invention can be applied to any environment or apparatus for displaying images, graphics, characters and text, and preferably, to the display panel of televisions, computers, printers, monitors, vehicles, to the display of signal machines, communication apparatus, telephones, lamp equipments, headlights, interactive electronic books, microdisplay, fishing devices, personal digital assistant (PDA), game means, airplane equipments and head mounted display.

The invention will be described specifically with reference to the following embodied example.

### PREPARATION EXAMPLE 1

Preparation of an OLED Panel

A substrate including a transparent electrode material of indium tin oxide (ITO) is patterned by photolithography to form parallel stripe-shaped transparent electrodes, and cleans thoroughly. Then, a photoresist layer having a uniform thickness is formed by spin coating to become a positive photoresist compound on the substrate. The substrate coated with the positive photoresist is pre-baked in a hot plate. Then, a photomask having stripe-shaped patterns is used to expose the substrate with an exposure apparatus. The substrate is post-exposure bake (PEB), and simultaneously is treated in an atmosphere full with tetramethyl ammonium hydroxide (TMAH). Parallel stripe-shaped photoresists perpendicular to the transparent ITO electrodes are formed on the substrate by development. The cross-sectional area of the parallel strip-shaped photoresist is shaped as a reversed trapezoid having a thickness of 0.8 μm and a width of 0.18 μm. Then, the strip-shaped photoresists then acts as a shadow mask, and a layer of TPD (N,N′-diphenyl-N,N′-bis(3-methyl phenyl)-1,1′-biphenyl-4,4′-diamine) having a thickness of 700 angstroms is formed in the area between the parallel photoresist rampart by vacuum evaporation. Then, a layer of Alq3 having a thickness of 500 angstroms is formed by vacuum evaporation. Finally, an aluminum cathode having a thickness of 1,000 angstroms is also formed by vacuum evaporation to bring about an OLED element.

### EXAMPLE 1

Parylene is formed on the surface of the OLED panel prepared in accordance with the preparation example 1 by VDP. A thin film (stress-relief layer) having a thickness of about 2 μm is formed by means of a vaporization chamber, a pyrolization chamber and a deposition chamber. The pressure in the vaporization chamber is 0.1 torr and the temperature is 175 degree Celsius. The pressure in the pyrolization chamber is 0.5 torr and the temperature is 680 degree Celsius. The pressure in the deposition chamber is 0.1 torr and the temperature is 25 degree Celsius.

A SiN passivation layer having a thickness of 200 nm is formed by conventional plate PECVD system wherein flow rate of SiH₄ is 1 sccm; flow rate of NH₃ is 19 sccm; RF power is 47 W; temperature is 25 degree Celsius and pressure is 0.32 torr. Hence, an OLED panel having a passivation layer and a stress-relief layer is formed. (as shown in FIG. 2)

The panel is placed into a high-temperature (65 degree Celsius) and high-humidity (95% relative humidity) chamber for testing the protection effect, and then, is removed from the chamber for inspection with eyes and a microscope. Observation of the panel indicates that the passivation layer and the stress-relief layer remain smooth without forming any wrinkle after undergoing the high temperature and high humidity test.

### EXAMPLE 2

Parylene is formed on the surface of the OLED panel of example 1 by VDP. A thin film (stress-relief layer) having a thickness of about 2 μm is formed by means of a vaporization chamber, a pyrolization chamber and a deposition chamber. The pressure in the vaporization chamber is 0.1 torr and the temperature is 175 degree Celsius. The pressure in the pyrolization chamber is 0.5 torr and the temperature is 680 degree Celsius. The pressure in the deposition chamber is 0.1 torr and the temperature is 25 degree Celsius. Hence, an OLED panel having a passivation layer, a stress-relief layer and a protective film is formed. (as shown in FIG. 3)

The panel is placed into a high-temperature (65 degree Celsius) and high-humidity (95% relative humidity) chamber for testing the protection effect, and then, is removed from the chamber for inspection with eyes and a microscope. Observation of the panel indicates that the stress-relief layer and the protective film remain smooth without forming any wrinkle after undergoing the high temperature and high humidity test.

### EXAMPLE 3

A layer of TPD (N,N′-diphenyl-N,N′-bis(3-methyl phenyl)-1,1′-biphenyl-4,4′-diamine) having a thickness of 700 angstroms is formed on the substrate including a transparent electrode material of ITO by vacuum evaporation. Then, a layer of Alq3 having a thickness of 500 angstroms is formed by vacuum evaporation. Finally, an aluminum cathode having a thickness of 1,000 angstroms is also formed by vacuum evaporation to bring about an OLED element.

An amorphous silicon layer having a thickness of 100 nm is formed by conventional plate PECVD system wherein flow rate of SiH₄ is 5 sccm; flow rate of H₂ is 2 sccm; RF power is 47 W; temperature is 60 degree Celsius and pressure is 0.32 torr. Hence, an OLED panel having an amorphous silicon passivation layer is formed.

The panel is placed into a high-temperature (65 degree Celsius) and high-humidity (95% relative humidity) chamber for testing the protection effect, and then, is removed from the chamber for inspection with eyes and a microscope. Observation of the panel indicates that the amorphous silicon layer remains smooth without forming any wrinkle after undergoing the high temperature and high humidity test.

### COMPARATIVE EXAMPLE 1

A SiN layer having a thickness of 0.5 μm is formed on the OLED panel prepared in accordance with the preparation example 1 by the conventional plate PECVD system wherein flow rate of SiH₄ is 1 sccm; flow rate of NH₃ is 19 sccm; RF power is 47 W; temperature is 25 degree Celsius and pressure is 0.32 torr. Hence, an OLED panel having a SiN layer is formed.

The panel is placed into a high-temperature (65 degree Celsius) and high-humidity (95% relative humidity) chamber for testing the protection effect, and then, is removed from the chamber for inspection with eyes and a microscope. Observation of the panel indicates that a number of wrinkles are formed because of the large stress in the layer. Therefore, the SiN material cannot be used to form a uniform protective film from moisture penetration.

### COMPARATIVE EXAMPLE 2

A SiN layer having a thickness of 1.5 μm is formed on the OLED panel prepared in accordance with the preparation example 1 by the conventional plate PECVD system wherein flow rate of SiH₄ is 1 sccm; flow rate of NH₃ is 19 sccm; RF power is 47 W; temperature is 25 degree Celsius and pressure is 0.32 torr. Hence, an OLED panel having a SiN layer is formed.

However, we found that a number of wrinkles are formed on the SiN layer of the OLED panel because of the large stress in the layer. Therefore, the SiN material cannot be used to form a uniform protective film from moisture infiltration.

Concluding from the above examples, the OLED panel fabricated in accordance with the present method comprises the stress relief layer, the passivation layer and the protective layer. The surface of the present OLED panel causes no wrinkle under the high-temperature and high-humidity environment. Hence, the passivation effect is excellent. Further, because the stress-relief layer is a thin film of SiON or polymer, the growing speed thereof is faster than that made of inorganic nitride or inorganic oxide. Hence, the processing speed of the OLEDs can be increased, and thus, the time for preparing the OLEDs will be shortened. Accordingly, the present invention is advantaged in improving the passivation function and the preparation time for the OLEDs. With these advantages, the present invention is adaptable for mass production.

Although the present invention has been explained in relation to its preferred embodiments, it is to be understood that many other possible modifications and variations can be made without departing from the spirit and scope of the invention as hereinafter claimed.

What is claimed is:

1. A method for fabricating an organic light-emitting device, comprising the following steps:
(A) providing a substrate;
(B) forming at least one first electrode corresponding to a light emission area on said substrate;
(C) forming a stripe-shaped photoresist layer on said substrate having said first electrode, wherein said photoresist layer is protruding from the surface of said substrate having said first electrodes;
(D) depositing at least one organic light-emitting medium on said first electrode in said exposed areas between said stripe-shaped photoresist layers;
(E) forming at least one second electrode on said organic light-emitting medium layer;
(F) forming a stress-relief layer on said second electrode wherein said stress-relief layer is a thin film of silicon oxynitride or polymer; and
(G) forming a passivation layer on said stress-relief layer wherein said passivation layer is an amorphous silicon, an inorganic nitride or an inorganic oxide.

2. The method as claimed in claim 1, further comprising said step of forming a protective layer on said passivation layer wherein said protective layer is a polymer film.

3. The method as claimed in claim 1, wherein said polymer film is PTFE.

4. The method as claimed in claim 1, wherein said nitride in passivation layer is silicon nitride, aluminum nitride or aluminum chromium nitride.

5. The method as claimed in claim 1, wherein said oxide in passivation layer is silicon oxide or aluminum oxide.

6. The method as claimed in claim 1, wherein said polymer film in stress-relief layer is formed by depositing parylene on said second electrode before its formation on said second electrode by vapor deposition polymerization or plasma-enhanced chemical vapor deposition (PECVD).

7. The method as claimed in claim 1, wherein said silicon oxynitride film is formed on said second electrode by plasma-enhanced chemical vapor deposition (PECVD).

8. The method as claimed in claim 1, wherein said amorphous silicon passivation layer is grown at a low-temperature.

9. The method as claimed in claim 1, wherein said protective polymer film is formed by depositing parylene on said passivation layer before its formation on said passivation layer by vapor deposition polymerization or plasma-enhanced chemical vapor deposition (PECVD).

10. A method for fabricating an organic light-emitting device, comprising said steps of:
(A) providing a substrate;
(B) forming at least one first electrode on said substrate;
(C) forming at least one organic light-emitting medium layer on said first electrode;
(D) forming at least one second electrode on said organic light-emitting medium layer; and
(E) forming a passivation layer on said second electrode wherein said passivation layer is an amorphous silicon.

11. The method as claimed in claim 10, further comprising said step of forming a stress-relief layer on said second electrode before formation of said water-proof layer, wherein said stress-relief layer is a thin film of silicon oxynitride or polymer.

12. The method as claimed in claim 11, wherein said polymer film is PTFE.

13. The method as claimed in claim 11, wherein said amorphous silicon is grown at a low-temperature.

14. An organic light-emitting device, comprising:
a substrate;
a plurality of first electrodes formed in parallel with each other on said substrate;
a plurality of stripe-shaped photoresists on said substrate having said first electrodes;
a plurality of organic light-emitting medium layers deposited on said first electrodes;
a plurality of second electrodes formed on said organic light-emitting medium layers;
a stress-relief layer which is a thin film of silicon oxynitride or polymer formed on said second electrodes; and
a passivation layer which is an amorphous silicon, an inorganic nitride or an inorganic oxide formed on said stress-relief layer.

15. The organic light-emitting device as claimed in claim 14, further comprising a protective layer wherein said protective layer is a polymer film on said passivation layer.

16. The organic light-emitting device as claimed in claim 14, wherein said polymer film is PTFE.

17. The organic light-emitting device as claimed in claim 14, wherein said nitride passivation layer is silicon nitride, aluminum nitride or aluminum chromium nitride.

18. The organic light-emitting device as claimed in claim 14, wherein said oxide passivation layer is silicon oxide or aluminum oxide.

19. The organic light-emitting device as claimed in claim 14, wherein said polymer film in stress-relief layer is formed by depositing parylene on said second electrode before its formation on said second electrode by vapor deposition polymerization or plasma-enhanced chemical vapor deposition (PECVD).

20. An organic light-emitting device, comprising:
a substrate;
at least one first electrode formed on said substrate;
at least one organic light-emitting medium layer deposited on said first electrode;
at least one second electrode formed on said organic light-emitting medium layer; and
a passivation layer which is an amorphous silicon formed on said second electrode.

21. The organic light-emitting device as claimed in claim 20, wherein said amorphous silicon is grown at a low temperature.
